(19) United States
(12) Patent Application Publication
(10) Pub. No.: US 2019/0082183 A1
(43) Pub. Date: Mar. 14, 2019

(54) Method and Apparatus for Video Coding of VR images with Inactive Areas

(71) Applicant: MEDIATEK INC., Hsin-Chu (TW)

(72) Inventors: Cheng-Hsuan SHIH, Hsinchu (TW); Jian-Liang LIN, Hsinchu (TW)

(21) Appl. No.: 16/127,954

(22) Filed: Sep. 11, 2018

Related U.S. Application Data
(60) Provisional application No. 62/557,785, filed on Sep. 13, 2017.

(51) Int. Cl. H04N 19/159; H04N 19/176; H04N 19/172; H04N 19/124; H04N 19/182; H04N 19/44; H04N 19/625

(52) U.S. Cl. CPC H04N 19/159; H04N 19/176; H04N 19/172; H04N 19/625; H04N 19/182; H04N 19/45; H04N 19/124

(57) ABSTRACT

Methods for processing 360-degree virtual reality images are disclosed. According to one method, coding flags for the target block are skipped for inactive blocks at an encoder side or pixels for the target block are derived based on information identifying the target block being the inactive block at a decoder side. According to another method, when a target block is partially filled with inactive pixels, the best predictor is selected using rate-distortion optimization, where distortion associated with the rate-distortion optimization is measured by excluding inactive pixels of the target block. According to another method, the inactive pixels of a residual block are padded with values to achieve the best rate-distortion optimization. According to another method, active pixels of the residual block are rearranged into a smaller block and coding is applied to the smaller block, or shape-adaptive transform coding is applied to the active pixels of the residual block.

### CROSS REFERENCE TO RELATED APPLICATIONS

The present invention claims priority to U.S. Provisional Patent Application Ser. No. 62/557,785, filed on Sep. 13, 2017. The U.S. Provisional Patent Application is hereby incorporated by reference in its entirety.

### FIELD OF THE INVENTION

The present invention relates to image processing for 360-degree virtual reality (VR) images. In particular, the present invention relates to improve compression efficiency for VR images including one or more inactive areas.

### BACKGROUND AND RELATED ART

The 360-degree video, also known as immersive video is an emerging technology, which can provide “feeling as sensation of present”. The sense of immersion is achieved by surrounding a user with wrap-around scene covering a panoramic view, in particular, 360-degree field of view. The “feeling as sensation of present” can be further improved by stereographic rendering. Accordingly, the panoramic video is being widely used in Virtual Reality (VR) applications.

Immersive video involves the capturing a scene using multiple cameras to cover a panoramic view, such as 360-degree field of view. The immersive camera usually uses a panoramic camera or a set of cameras arranged to capture 360-degree field of view. Typically, two or more cameras are used for the immersive camera. All videos must be taken simultaneously and separate fragments (also called separate perspectives) of the scene are recorded. Furthermore, the set of cameras are often arranged to capture views horizontally, while other arrangements of the cameras are possible.

The 360-degree virtual reality (VR) images may be captured using a 360-degree spherical panoramic camera or multiple images arranged to cover all filed of views around 360 degrees. The three-dimensional (3D) spherical image is difficult to process or store using the conventional image/video processing devices. Therefore, the 360-degree VR images are often converted to a two-dimensional (2D) format using a 3D-to-2D projection method. For example, equirectangular projection (ERP) and cubemap projection (CMP) have been commonly used projection methods. Accordingly, a 360-degree image can be stored in an equirectangular projected format. The description of other widely used projection formats, such as octahedron projection (OHP), icosahedron projection (ISP), segmented sphere projection (SSP) and rotated sphere projection (RSP), barrel layout and Craster parabolic projection (CPP) have been disclosed in various literatures. Therefore, the details of these projection formats are not recited here.

In order to form rectangular 2D projection frames, the 2D projection frames often are padded with inactive area(s). For example, an SSP projection frame 110 is shown in FIG. 1. The inactive areas 120 around the two circular images of the frame corresponding to the North Pole and South Pole areas of a globe are also shown in FIG. 1. An RSP projection frame 210 is shown in FIG. 2. The inactive areas 220 around the two oval-shaped images are also shown in FIG. 2. A CMP projection frame 310 with 3×4 layout is shown in FIG. 3. The inactive areas 320 to fill up the rectangular frame are also shown in FIG. 3. Another CMP projection frame 410 with 3×4 layout is shown in FIG. 4. The inactive areas 420 to fill up the rectangular frame are also shown in FIG. 4.

Barrel layout is a new layout format that is disclosed in recent years. For the equirectangular projection (ERP) format, the top part and the bottom part are stretched substantially in the horizontal direction. However, if the top 25 percent and bottom 25 percent of an image formatted in an equirectangular layout are cut, the remaining part corresponds to the middle 90 degrees of the scene which contains a quite uniform angular sample distribution. This middle part is then stretched vertically to increase pixel density in the specific area desired. To cover the rest of the sphere, the top and bottom faces from the cube map layout particular, the middle circle of these faces are joined with the stretched middle part to form a frame in the barrel layout format. FIG. 5 illustrates an example of a barrel layout frame 510, where the stretched middle part is positioned in the left side of the frame and the two circles are on the right side of the frame. Inactive areas 520 are added around the two circles as shown in FIG. 5.

The Craster parabolic projection (CPP) is a pseudo-cylindrical, equal area projection. The central meridian is a straight line half as long as the equator and other meridians are equally spaced parabolas intersecting at the poles and concave toward the central meridian. FIG. 6 illustrates an example of a Craster parabolic projection frame 610. Inactive areas 620 are added around the Craster parabolic projection image as shown in FIG. 6.

An icosahedron projection (ISP) projection frame 710 is shown in FIG. 7. The inactive areas 720 to fill up the rectangular frame are also shown in FIG. 7. Another ISP projection frame 810 is shown in FIG. 8. The inactive areas 820 to fill up the rectangular frame are also shown in FIG. 8. An octahedron projection (OHP) projection frame 910 is shown in FIG. 9. The inactive areas 920 to fill up the rectangular frame are also shown in FIG. 9.

When the projection frames are coded, the inactive areas in the 2D projection frames will consume some bandwidth. Furthermore, the discontinuities between the projected image and the inactive areas may cause more prominent coding artifacts. Therefore, it is desirable to develop methods that can reduce the bitrate and/or alleviate the visibility of artifacts at the discontinuities between the projected image and the inactive areas.

### BRIEF SUMMARY OF THE INVENTION

Methods of processing 360-degree virtual reality images are disclosed. According to one method, input data for a 2D (two-dimensional) frame are received, where the 2D frame is projected from a 3D (three-dimensional) sphere using a target projection and the 2D frame comprises one or more inactive areas filled with inactive pixels. The 2D frame is divided into multiple blocks. When a target block is an inactive block with all pixels being inactive pixels, coding flags for the target block are skipped at an encoder side or pixels for the target block are derived based on information identifying the target block being the inactive block at a decoder side. The coding flags may comprise one or more elements selected from a group including prediction mode, prediction information, split mode and residual coefficient. Default coding flags may be assigned to the coding flags at the encoder side or the decoder side.

According to a second method, when a target block is partially filled with inactive pixels, for at least one candidate reference block in a selected reference picture area, inactive pixels in the candidate reference block are identified, or for at least one candidate Intra prediction mode in an Intra prediction group, one or more reference samples in a candidate Intra predictor associated with said at least one candidate Intra prediction mode are padded with a nearest available reference or said at least one candidate Intra prediction mode is removed from the Intra prediction group if said one or more reference samples are unavailable; a best predictor is selected among candidate reference blocks in the selected reference picture area or among candidate Intra predictors associated with candidate Intra prediction modes in the Intra prediction group according to rate-distortion optimization; and the target block is encoded using the best predictor.

For the second method, inactive pixels of the candidate reference block can be replaced by a default value before the best predictor is used for encoding the target block. In another embodiment, inactive pixels of the best predictor selected among the candidate Intra predictors associated with candidate Intra prediction modes in the Intra prediction group can be replaced by a default value before the best predictor is used for encoding the target block. In one embodiment, distortion associated with the rate-distortion optimization can be measured by excluding inactive pixels of the target block. In another embodiment, the distortion associated with the rate-distortion optimization can be measured according to a sum of absolute differences between the target block and one candidate reference block or between the target block and one candidate Intra predictor.

According to a third method, when a target block is partially filled with inactive pixels: a residual block is generated for the target block using an Inter predictor or an Intra predictor; inactive pixels of the residual block are padded with residual values to generate a padded residual block by choosing the residual values to achieve best rate-distortion optimization for the padded residual block; a reconstructed padded residual block is generated by applying a coding process to the padded residual block; and inactive pixels of the reconstructed padded residual block are trimmed to generate a reconstructed residual block for reconstructing the target block.

For the third method, distortion associated with the rate-distortion optimization can be measured according to a sum of absolute differences between the padded residual block and the reconstructed padded residual block. In another embodiment, distortion associated with the rate-distortion optimization is measured by excluding inactive pixels of the padded residual block. The coding process may comprise forward transform, quantization, inverse quantization and inverse transform.

According to a fourth method, when a target block is partially filled with inactive pixels: a residual block is generated for the target block using an Inter predictor or an Intra predictor at an encoder side or deriving the residual block from a video bitstream at a decoder side; and the residual block is encoded by applying a first coding process comprising a forward transform to a smaller rectangular block by re-arranging active pixels of the residual block or by applying a second coding process comprising a non-rectangle forward transform to the active pixels of the residual block at the encoder side, or the residual block is decoded using a third coding process comprising an inverse transform to residual block re-arranged in the smaller rectangular block or by applying a fourth coding process comprising a non-rectangle inverse transform to the active pixels of the residual block at the decoder side.

For the fourth method, the non-rectangle forward transform may correspond to forward shape-adaptive transform and the non-rectangle inverse transform corresponds to inverse shape-adaptive transform. The forward shape-adaptive transform process may comprise a first 1-D DCT (discrete cosine transform) process in a first direction, aligning first results of the first 1-D DCT process to a first board in the first direction, a second 1-D DCT process in a second direction, and aligning second results of the second 1-D DCT process to a second board in the second direction; and the inverse shape-adaptive transform process may comprise a first inverse 1-D DCT process in the first direction, restoring first results of the first inverse 1-D DCT process to original first positions in the first direction, a second inverse 1-D DCT process in the second direction, restoring second results of the second inverse 1-D DCT process to original second positions in the second direction.

### BRIEF DESCRIPTION OF THE DRAWINGS

FIG. 1 illustrates an example of a segmented sphere projection (SSP) projection frame, where the inactive areas around the two circular images of the frame corresponding to the North Pole and South Pole areas of a globe are shown.

FIG. 2 illustrates an example of a rotated sphere projection (RSP) projection frame, where inactive areas around the two oval-shaped images are shown.

FIG. 3 illustrates an example of a cubemap projection (CMP) projection frame with 3×4 layout, where inactive areas are filled with a gray level.

FIG. 4 illustrates an example of another cubemap projection (CMP) projection frame with 3×4 layout, where inactive areas are filled with a black level.

FIG. 5 illustrates an example of a barrel layout frame, where the stretched middle part is positioned in the left side of the frame and the two circles are on the right side of the frame. Inactive areas are added around the two circles.

FIG. 6 illustrates an example of a Craster parabolic projection (CPP) projection frame, where inactive areas are added around the Craster parabolic projection image.

FIG. 7 illustrates an example of an icosahedron projection (ISP) projection frame, where inactive areas to fill up the rectangular frame are shown.

FIG. 8 illustrates another example of an icosahedron projection (ISP) projection frame, where inactive areas to fill up the rectangular frame are shown.

FIG. 9 illustrates an example of an octahedron projection (OHP) projection frame, where inactive areas to fill up the rectangular frame are shown.

FIG. 10 illustrates a part of an SSP frame, where one CU is fully within an inactive area and another CU is partially within an inactive area.

FIG. 11A illustrates a reference frame corresponding to a previously coded projection frame for the segmented sphere projection (SSP) project format.

FIG. 11B illustrates an example of padding the areas outside the square enclosing the two circles representing the North Pole and South Pole with a default pixel value and using geometry padding for the image corresponding to the equator.

FIG. 11C illustrates an example of padding the areas outside the two circles representing the North Pole and South Pole using geometry padding.

FIG. 12 illustrates an example of Inter prediction process for a block with partial inactive pixels according to an embodiment of the present invention, where a part of an SSP frame and a current CU with partial inactive pixels located at the boundary of the circular image corresponding to the South Pole are illustrated.

FIG. 13 illustrates an example of Intra prediction process for a block with partial inactive pixels according to an embodiment of the present invention, where a part of an SSP frame and a current CU located at the boundary of the circular image corresponding to the South Pole with partial inactive pixels are illustrated.

FIG. 14 illustrates an example of conventional Intra prediction and an embodiment of Intra prediction according to the present invention that pads unavailable reference pixels in the inactive area by a nearest available reference pixel.

FIG. 15 illustrates an example of padding of unavailable reference pixels (e.g. inactive pixel, outside face pixel and another-face pixel) with nearest available reference pixels according to an embodiment of the present invention.

FIG. 16 illustrates an example of coding a projection frame according to an embodiment of the present invention, where if the Intra predictor associated with an Intra prediction mode refers to any unavailable reference pixel, the Intra prediction mode will be excluded from an Intra prediction candidate set for the current block.

FIG. 17 illustrates an example of inactive blocks in a projection frame, where the inactive blocks are indicated by areas filled with a solid gray color.

FIG. 18 illustrates an example of residual coding according to one embodiment of the present invention, where inactive pixels of the residual are padded with values that achieve the optimal RD 0 (rate-distortion optimization) for residual coding.

FIG. 19 illustrates an example of residual coding according to another embodiment of the present invention, where active pixels of the residual block are rearranged into a smaller block and coding is applied to the smaller block, or shape-adaptive transform coding is applied to the active pixels of the residual block.

FIG. 20 illustrates an exemplary flowchart of a coding system for processing 360-degree virtual reality images, where coding flags for inactive blocks are skipped.

FIG. 21 illustrates an exemplary flowchart of a coding system for processing 360-degree virtual reality images, where partially inactive blocks are coded in the Intra or Inter prediction mode.

FIG. 22 illustrates an exemplary flowchart of a coding system for processing 360-degree virtual reality images, where the inactive pixels of a residual block are padded with values to achieve the best rate-distortion optimization.

FIG. 23 illustrates an exemplary flowchart of a coding system for processing 360-degree virtual reality images, where active pixels of the residual block are rearranged into a smaller block and coding is applied to the smaller block, or shape-adaptive transform coding is applied to the active pixels of the residual block.

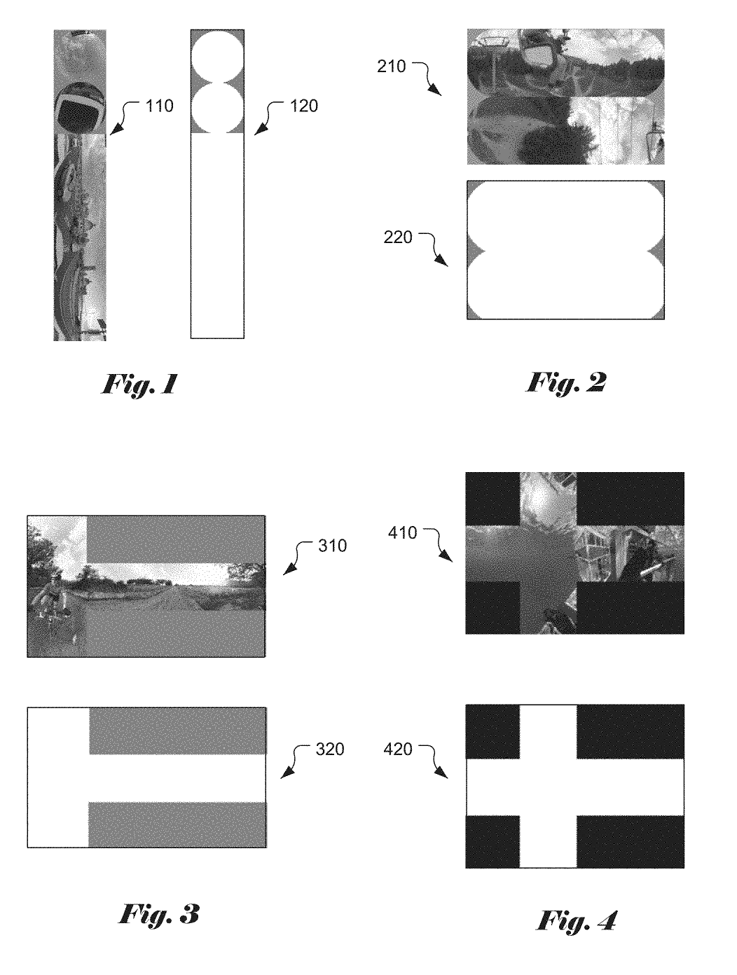

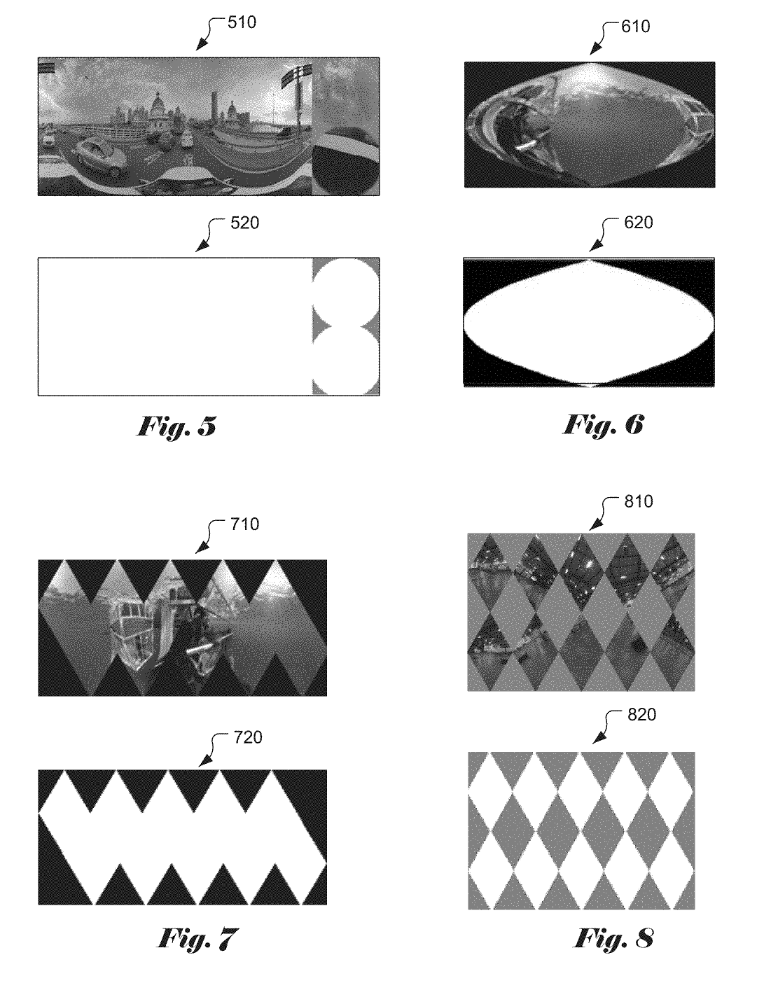

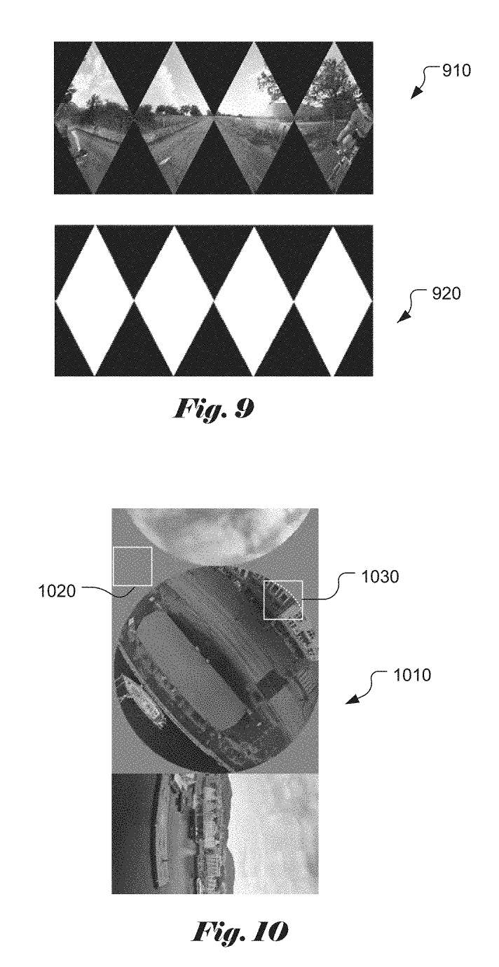

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

As mentioned above, the inactive areas in the 2D projection frames will consume some bandwidth and the discontinuities between the projected image and the inactive areas may cause more prominent coding artifacts. In order to overcome the issues related to inactive areas, methods focusing on processing inactive pixels or areas near inactive pixels are disclosed. The proposed methods can improve compression efficiency and visual quality by enhance prediction accuracy and lower the distortion. The proposed methods can be applied on Inter prediction, Intra prediction, and residual coding.

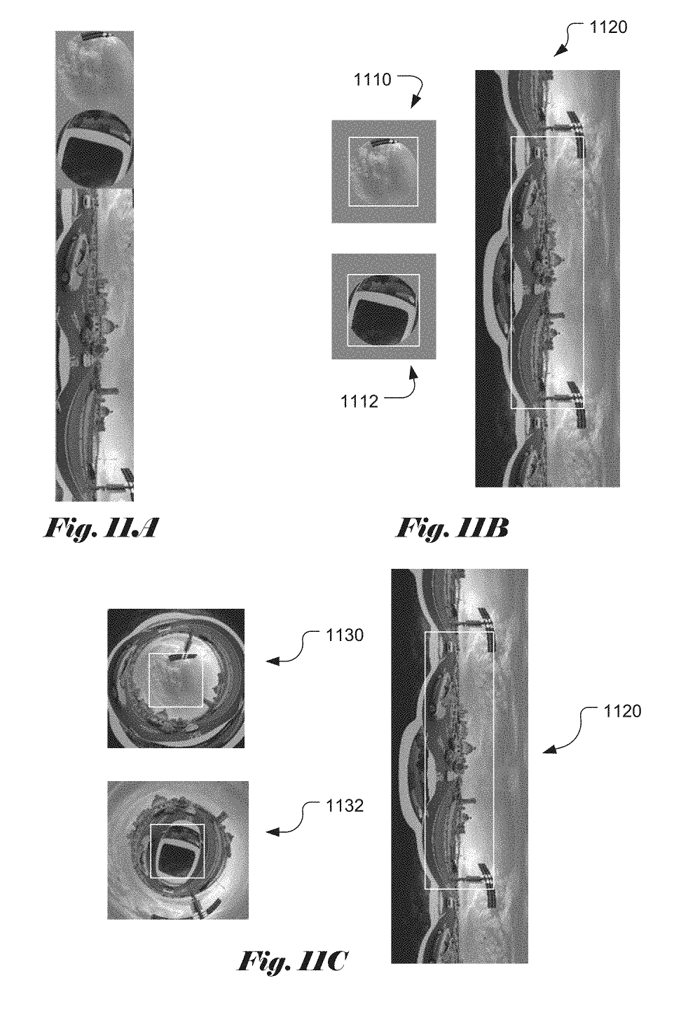

In order to maintain manageable complexity, an image is often divided into blocks, such as macroblock (MB) or coding unit (CU) to apply video coding. When a projection frame with inactive areas is coded by dividing the frame into the coding units (CUs), a CU may be fully within an inactive area or partially within an inactive area. FIG. 10 illustrates a part of an SSP frame 1010, where a CU (1020) is fully within an inactive area and another CU (1030) is partially within an inactive area. For a CU with all pixels being inactive pixels, all coding flags such as the prediction mode, prediction information, split mode, residual coefficient, and other relative flags for the CU are not coded according to the present invention. The predictor of each pixel of the CU is a default value of inactive pixel (e.g. a gray level or other known value) and residuals are 0. For a CU with partial inactive pixels, the predictor of inactive pixels can be a default value. The residuals of inactive pixels are 0. The prediction error will only take into account the active pixels for the rate-distortion optimization (RDO) process. In other words, for a CU with all pixels being inactive pixels, the encoding of the inactive CU is skipped. For a CU with partial inactive pixels, inactive pixels of the predictor (either an Inter prediction or Inter prediction) can be trimmed. The residual coding of a CU with partial inactive pixels may comprises padding inactive pixels of residual, applying a non-rectangle DCT transform to residual coding, or rearranging the non-rectangle shape of residual into a smaller rectangle than the original block before applying DCT.

In the conventional approach, a previously coded projection frame may be used as a reference frame. For example, FIG. 11A illustrates a reference frame corresponding to a previously coded projection frame for the SSP project format. According to an embodiment of the present invention, images outside the projection frame may be padded. For example, the areas outside the square enclosing the two circles representing the North Pole and South Pole can be padded with a default pixel value. For example, the default value may be the same as the inactive pixel value as shown in padded images 1110 and 1112 as shown in FIG. 11B. For the image corresponding to the equator, geometry padding can be used to form a padded image 1120 as shown in FIG. 11B, wherein the geometry padding extends pixels around the image boundaries by considering the spherical nature of the 360 video. Geometry padding for various projection formats has been known in the literature (e.g. Y. He et al., “AHG8. Geometry padding for 360 video coding”, Joint Video Exploration Team (JVET) of ITU-T SG 16 WP 3 and ISO/IEC JTC 1/SC 29/WG 11, 4th Meeting: Chengdu, CN, 15-21 Oct. 2016, Document: JVET-D0075). Accordingly, details of geometry padding are not repeated here. The two circular images corresponding to the North Pole and the South Pole may also be padded using geometry padding. The geometry padded North Pole image 1130 and South Pole image 1132 are shown in FIG. 11C.

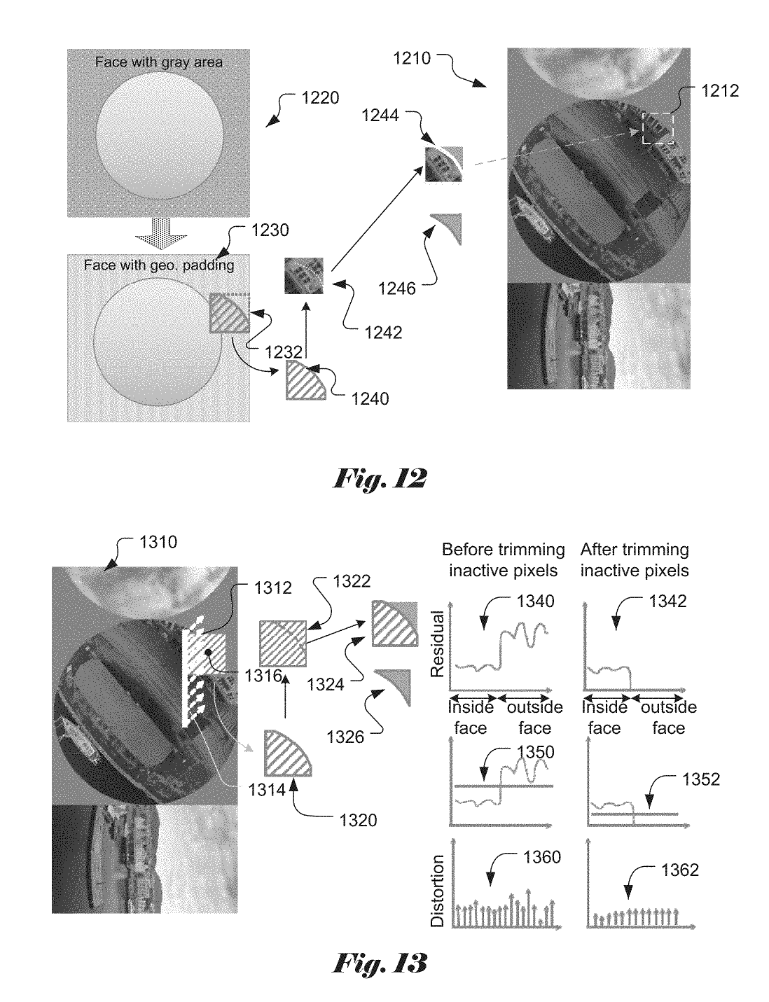

According to one embodiment of the present invention, the Inter prediction can be performed using geometry padded reference image. For example, the faces with geometry padding (e.g. geometry padded North Pole image 1130 and South Pole image 1132) can be used as reference images to derive predictors. FIG. 12 illustrates an example of Inter prediction process for a block (e.g. CU) with partial inactive pixels according to an embodiment of the present invention. In FIG. 12, a part of an SSP frame 1210 and a current CU 1212 with partial inactive pixels are illustrated, where the partial inactive CU 1212 is located at the boundary of the circular image corresponding to the South Pole. The face padded with gray area 1220 corresponding to the South Pole is shown in FIG. 12. The geometry padding is applied to the face of the image 1220 padded with gray area to form a geometry-padded face image 1230. A matching method can be applied to search for a best-matched block in the geometry-padded face image 1230 for the current block 1212. For example, the popular block matching algorithm can be used. The distortion measure can be based on SAD (sum of absolute differences) between the current block and a candidate reference block. During the best match searching process, the weighting of the inactive pixels are set to 0. In other words, the matching process disregards the contribution from the inactive pixels. In FIG. 12, block 1232 corresponds the best matched block. The active area 1240 of this best matched block can be identified. The reference block 1242 corresponding to best matched block 1232 is shown, where active area of the block (i.e., block 1244) is used as the predictor for the current block 1212 while the inactive area 1246 is not used for the predictor.

FIG. 13 illustrates an example of Intra prediction process for a block (e.g. CU) with partial inactive pixels according to an embodiment of the present invention. In FIG. 13, a part of an SSP frame 1310 and a current CU 1312 with partial inactive pixels are illustrated, where the partial inactive CU 1312 is located at the boundary of the circular image corresponding to the South Pole. Among various Intra predictors, the one that results in the best rate-distortion optimization is selected as the Intra predictor, where the weighting of distortion measure for the inactive pixels is set to 0. The distortion measure can be based on SAD (sum of absolute differences) between the current block and a candidate Intra prediction block. In the example of FIG. 13, the prediction direction 1314 achieves the best prediction. The Intra predictor 1316 as shown by the slant lines corresponds to the best predictor. The active region 1320 of the Intra predictor can be identified. According to an embodiment of the present invention, the active part and inactive part of the Intra predictor 1322 can be identified (as separated by the dashed arc line). The inactive part 1326 can be trimmed and only the active part 1324 is used as the Intra predictor for the current block 1312. The residuals without and with trimming are shown in chart 1340 and chart 1342, where the residual forced to 0 in the outside face (i.e., the inactive area). Charts 1350 and 1352 show the reconstructed residuals for the cases without trimming and with trimming respectively. The distortion is shown in chart 1360 and chart 1362 for the cases without trimming and with trimming respectively.

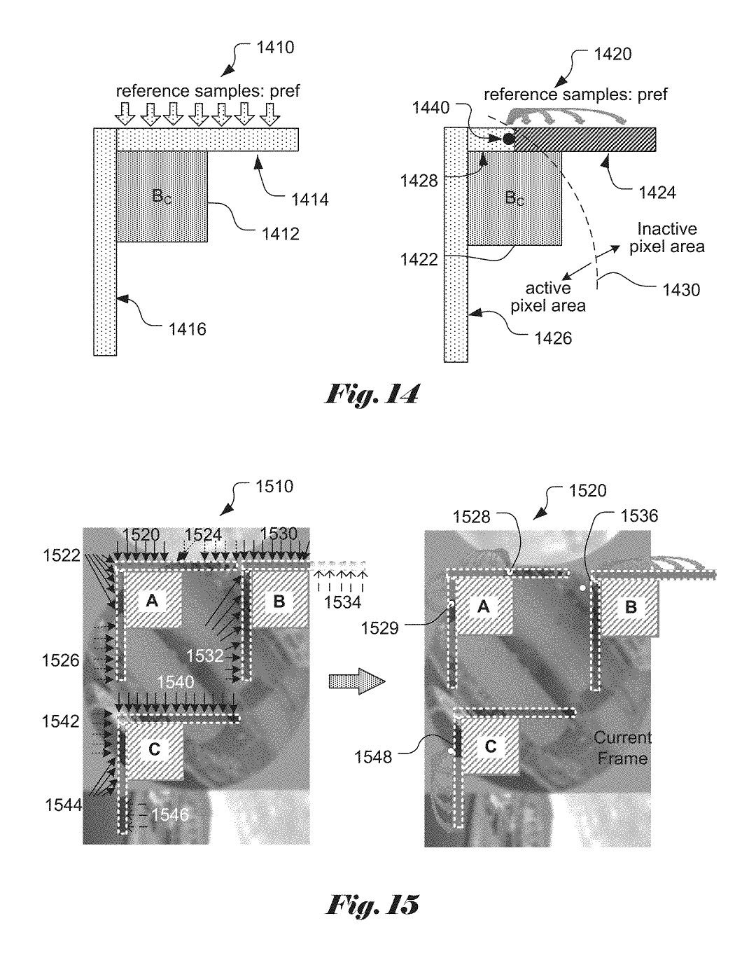

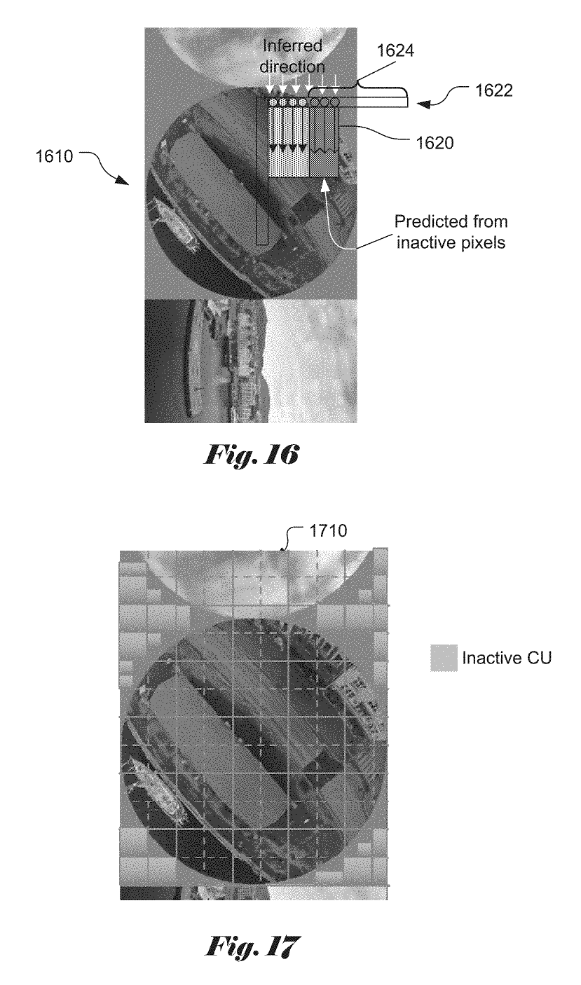

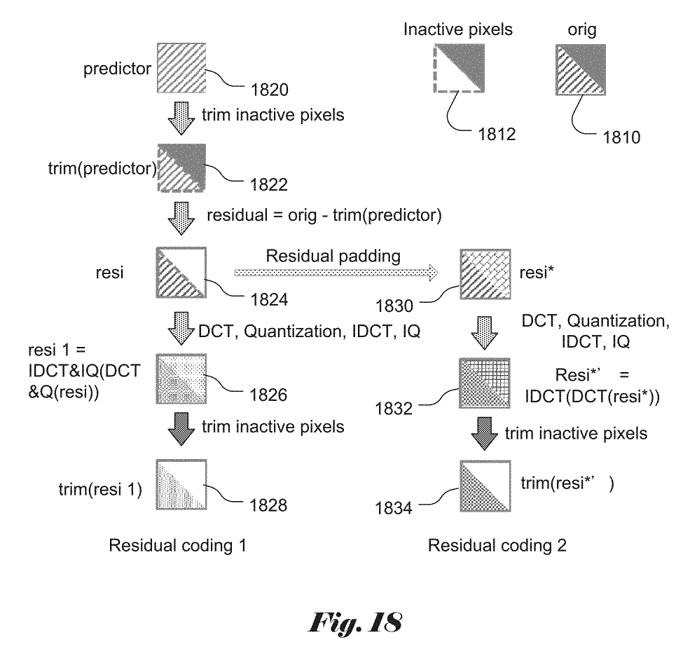

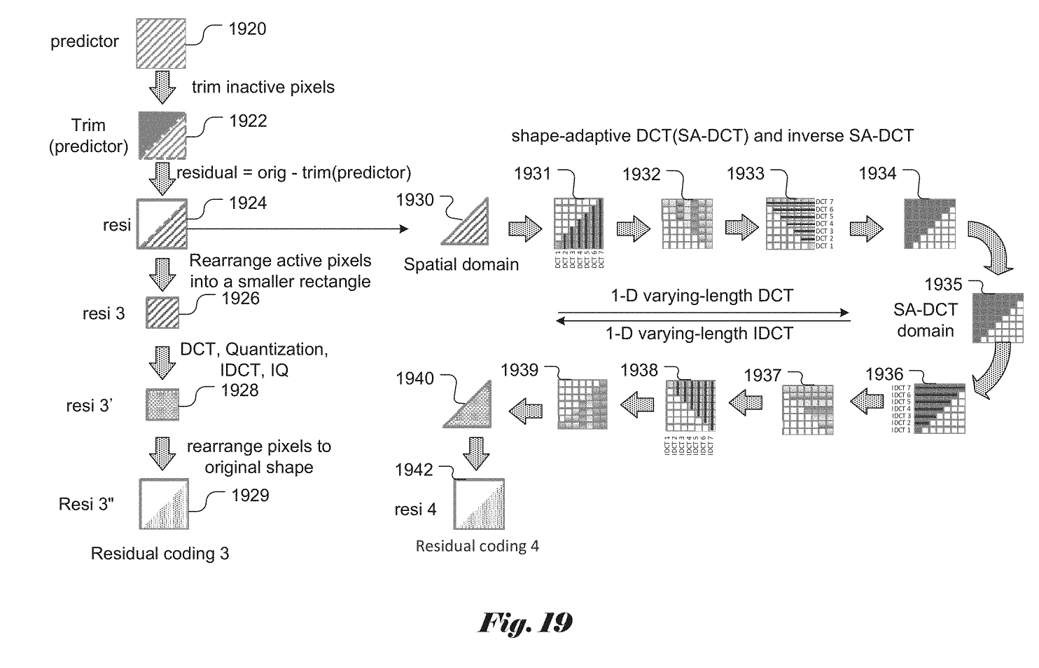

In another embodiment of the present invention, padding is used for reference samples in the inactive pixel area for Intra pixel. For conventional Intra prediction 1410 in FIG. 14, previously coded reference pixels around a current block are used to generate the Intra predictor for the current block. For example, the reference pixels above 1414 and the reference pixels to the left 1416 of the current block may be used to generate the Intra predictor. Usually, the encoder will check various Intra prediction modes (e.g. DC, planar, and directional modes) and select one that achieves the best performance (e.g. the minimum distortion). However, for a project frame including inactive areas, some or all reference pixels for a current block may not be available. The Intra prediction 1420 in FIG. 14 illustrates an example of unavailable reference pixels due to inactive area. In this example, some reference pixels 1424 above the current block 1422 are unavailable. Arc 1430 corresponds to a boundary for inactive area (the area to the right) and active area (the area to the left). Therefore only the reference pixels 1426 to the left and partial reference pixels 1428 on the top are available. An embodiment of the present invention will utilize the available reference pixels to fill the unavailable pixels. For example, the unavailable pixels can be filled with the nearest available reference pixel 1440.

The reference pixels may also across various types of pixels, such as active pixels, inactive pixels, outside face pixels and another-face pixels. In another embodiment of the present invention, any inactive pixel, outside face pixel and another-face pixel are considered unavailable and the unavailable reference pixels are filled with the nearest reference pixels. FIG. 15 illustrates an example of padding of unavailable reference pixels, where image 1510 corresponds to a part of an SSP image around the South Pole. Blocks A, B and C are three blocks to be Intra predicted. The reference pixels are indicated by the areas enclosed by dashed lines. For block A, reference pixels 1520 and 1522 are inactive pixels and reference pixels 1524 and 1526 are active pixels. Therefore, reference pixels 1520 and 1522 are unavailable. For block B, reference pixels 1530 are inactive, 1532 are active pixels and reference pixels 1534 are outside-face pixels. Therefore, reference pixels 1530 and 1534 are unavailable. For block C, reference pixels 1540 and 1542 are active pixels, reference pixels 1544 are inactive pixels and pixels 1546 are another-face pixels. Therefore, reference pixels 1544 and 1546 are unavailable.

According to an embodiment of the present invention, the nearest available reference pixels are used to fill the unavailable reference pixels. In FIG. 15, image 1520 is used to illustrate pixel padding according to an embodiment of the present invention. For block A, the nearest available reference pixel 1528 is used to fill the inactive pixels to the left of the reference pixel 1528 (i.e., pixels 1520 in image 1510) and the nearest available reference pixel 1529 is used to fill the inactive pixels above (i.e., inactive pixels 1522 in image 1510). For block B, the nearest available reference pixel 1536 is used to fill the unavailable pixels above the block (i.e., inactive pixels 1530 and outside-face pixels 1534 in image 1510). For block C, the nearest available reference pixel 1548 is used to fill the unavailable pixels below (i.e., inactive pixels 1544 and another-face pixels 1546 in image 1510).

In FIG. 16, image 1610 corresponds to a part of an SSP image around the South Pole and block 1620 is a current block to be Intra predicted. For the reference pixels 1622 above the current block, some of them (1624) are unavailable (e.g. inactive, outside-face or another-face). When these unavailable pixels are used to generate the Intra predictor according to a selected Intra prediction mode (e.g. vertical prediction as shown in FIG. 16), some pixels of the Intra predictor may be generated from the unavailable reference pixels (i.e., inactive reference pixels in this case). The prediction from the inactive pixels may cause large prediction errors. According to another embodiment of the present invention, for any Intra prediction mode, if a certain amount of samples of predictor associated with the Intra prediction mode will refer to any unavailable reference pixel (i.e., an inactive pixel in this example), the Intra prediction mode will be excluded from an Intra prediction candidate set for the current block. The total number of allowed Intra prediction modes will be reduced. The coding performance may be improved.

For the projection frames, a block may be fully in the inactive area. When all pixels in a block (e.g. a CU) are inactive pixels, the block is called an inactive block. In FIG. 17, image 1710 corresponds to a part of an SSP image around the South Pole and the inactive blocks are shown as indicated by areas filled with a solid gray color. According to an embodiment of the present invention, coding flags such as the prediction mode, prediction information, split mode, residual coefficient, and other relative information for the inactive CUs are not encoded. Because the CU information is not be encoded for the inactive CU, we only need to assign a set of predefined information for the inactive CUs so that decoder will use the same information for the inactive CUs. For example, we can assign the prediction mode as Intra-mode; skip residual coding; set pixel value of block predictor to be a default value; not to further split the inactive CU; and so on.

Residual coding according to one embodiment of the present invention is shown in FIG. 18. According to this embodiment, an inactive pixel area of the residual is padded with values that achieve the optimal RDO (rate-distortion optimization) for residual coding. In FIG. 18, a current original block 1810 to be predicted includes an inactive part 1812. A predictor 1820 (Inter or Intra predictor) is generated for the current block. The area of the predictor corresponding to the inactive part is trimmed to form a trimmed predictor 1822. The prediction residual 1824 (i.e., difference between the trimmed predictor and the original data) can be derived. According to one embodiment, the residual 1824 will be coded and decoded (e.g. DCT=>quantization=>inverse quantization=>inverse DCT) to generate reconstructed residual 1826. The inactive area of the reconstructed residual 1826 can be trimmed to generate trimmed-reconstructed residual 1828 for further coding process. According to another embodiment, the residual can be padded to form a padded residual 1830 by padding with values to achieve the best RDO. The residual padded 1830 will be coded and decoded (e.g. DCT=>quantization=>inverse quantization=>inverse DCT) to generate reconstructed padded residual 1832. During the RDO process, the distortion will be evaluated for the active area of the residual block. The inactive area of the reconstructed padded residual 1832 can be trimmed to form trimmed reconstructed residual 1834. Since the padding for the padded residual 1830 is selected to achieve the best RDO performance, the final reconstructed residual (i.e., the trimmed reconstructed residual) should result in the minimum distortion at a given bitrate.

According to another embodiment, an inactive pixel area of the residual can be excluded from the coding process by applying DCT to a reduced block corresponding to the active area or applying shape-adaptive DCT (SA-DCT). In FIG. 19, a predictor 1920 (Inter or Intra predictor) is generated for the current block. The area of the predictor corresponding to the inactive part is trimmed to form a trimmed predictor 1922. The prediction residual 1924 (i.e., difference between the trimmed predictor and the original data) can be derived. According to one embodiment, the active pixels of the residual 1924 will be used to form a smaller block 1926, which is coded and decoded (e.g. DCT=>quantization=>inverse quantization=>inverse DCT) to generate reconstructed smaller residual 1928. The inactive pixels are added back to the reconstructed smaller residual 1928 to restore the reconstructed residual 1929. According to another embodiment of the present invention, a non-rectangular block can be coded. For example, the shape-adaptive DCT (discrete cosine transform) can be applied to the active pixels of the residual 1924. As is known in the field, the shape information or the contour information has to be transmitted to a receiver end before the inverse SA-DCT process can be performed. According to SA-DCT, the 1-D DCT, as shown in block 1931, is applied to the active pixels of the residual 1930 in the vertical direction, where the DCT size is dependent on the number of active pixels in the vertical direction. The coefficients of the 1-D DCT are shifted vertically and aligned with the upper boarder of the block to form the aligned block 1932. The 1-D DCT, as shown in block 1933, is then applied to the active samples of the aligned block 1932 in the horizontal, where the DCT size is dependent on the number of active pixels in the horizontal direction. The coefficients of the transform block are shifted horizontally and aligned with the left boarder to form SA-DCT block 1934. The SA-DCT block 1934 is then coded and decoded (i.e., quantized and inverse quantized) to form a reconstructed SA-DCT block 1935. Inverse SA-DCT is applied to the reconstructed SA-DCT block 1935 by applying 1-D DCT in the horizontal direction as shown in block 1936. The original pixel locations in the horizontal direction are restored as shown in block 1937. The 1-D DCT is then applied in the vertical direction as shown in block 1938 and the pixel location in the vertical direction is restored as shown in block 1939 to obtain reconstructed block 1940. The reconstructed residual with the inactive area filled become the fully reconstructed residual 1942, which can be used with the predictor to reconstruct the original signal.

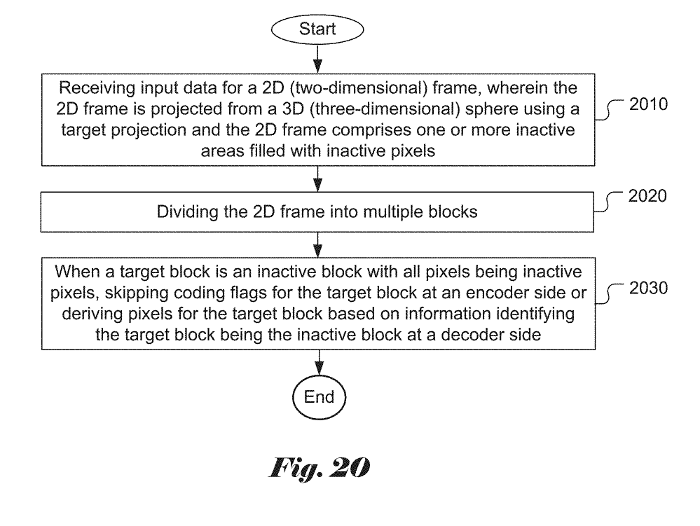

FIG. 20 illustrates an exemplary flowchart of a coding system for processing 360-degree virtual reality images, where coding flags for inactive blocks are skipped. The steps shown in the flowchart may be implemented as program codes executable on one or more processors (e.g., one or more CPUs) at an encoder side or decoder side. The steps shown in the flowchart may also be implemented based hardware such as one or more electronic devices or processors arranged to perform the steps in the flowchart. According to this embodiment, input data for a 2D (two-dimensional) frame are received in step 2010, where the 2D frame is projected from a 3D (three-dimensional) sphere using a target projection and the 2D frame comprises one or more inactive areas filled with inactive pixels. As disclosed earlier, various projection formats may be used to generate the 2D frame. The 2D frame is divided into multiple blocks for processing in step 2020. The blocks may correspond to coding units (CUs). When a target block is an inactive block with all pixels being inactive pixels, coding flags for the target block are skipped at an encoder side or pixels for the target block are derived based on information identifying the target block being the inactive block at a decoder side in step 2030.

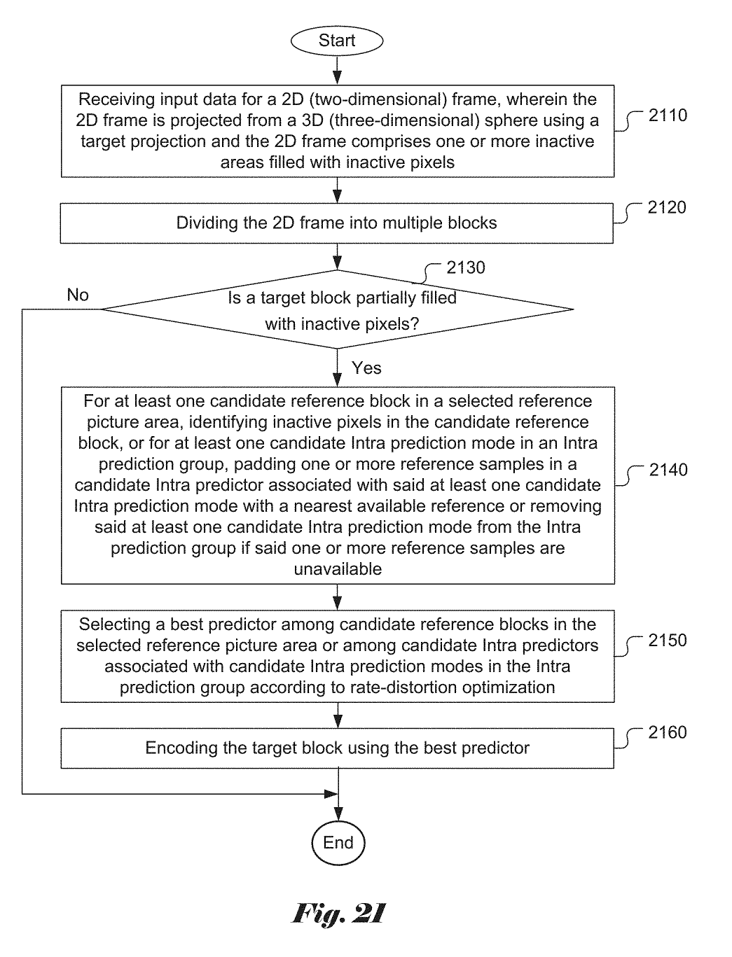

FIG. 21 illustrates an exemplary flowchart of a coding system for processing 360-degree virtual reality images, where partially inactive blocks are coded in the Intra or Inter prediction mode. According to this embodiment, input data for a 2D (two-dimensional) frame are received in step 2110, where the 2D frame is projected from a 3D (three-dimensional) sphere using a target projection and the 2D frame comprises one or more inactive areas filled with inactive pixels. The 2D frame is divided into multiple blocks for processing in step 2120. Whether a target block is partially filled with inactive pixels is checked in step 2130. If the target block is partially filled with inactive pixels (i.e., the “yes” path from step 2130), steps 2140 to 2160 are performed. Otherwise (i.e., the “no” path from step 2130), steps 2140 to 2160 are skipped. In step 2140, for at least one candidate reference block in a selected reference picture area, inactive pixels in the candidate reference block are identified, or for at least one candidate Intra prediction mode in an Intra prediction group, one or more reference samples in a candidate Intra predictor associated with said at least one candidate Intra prediction mode are padded with a nearest available reference or said at least one candidate Intra prediction mode from the Intra prediction group is removed if said one or more reference samples are unavailable. The candidate reference block is intended for Inter prediction if the Inter prediction is selected for the target block. In step 2150, a best predictor is selected among candidate reference blocks in the selected reference picture area or among candidate Intra predictors associated with candidate Intra prediction modes in the Intra prediction group according to rate-distortion optimization. As is known for Inter prediction, the best predictor is searched for candidate reference blocks in a selected reference picture area. For Intra prediction, the best prediction is selected among an allowed Intra prediction mode group. After the best predictor is selected, the target block is encoded using the best predictor in step 2160.

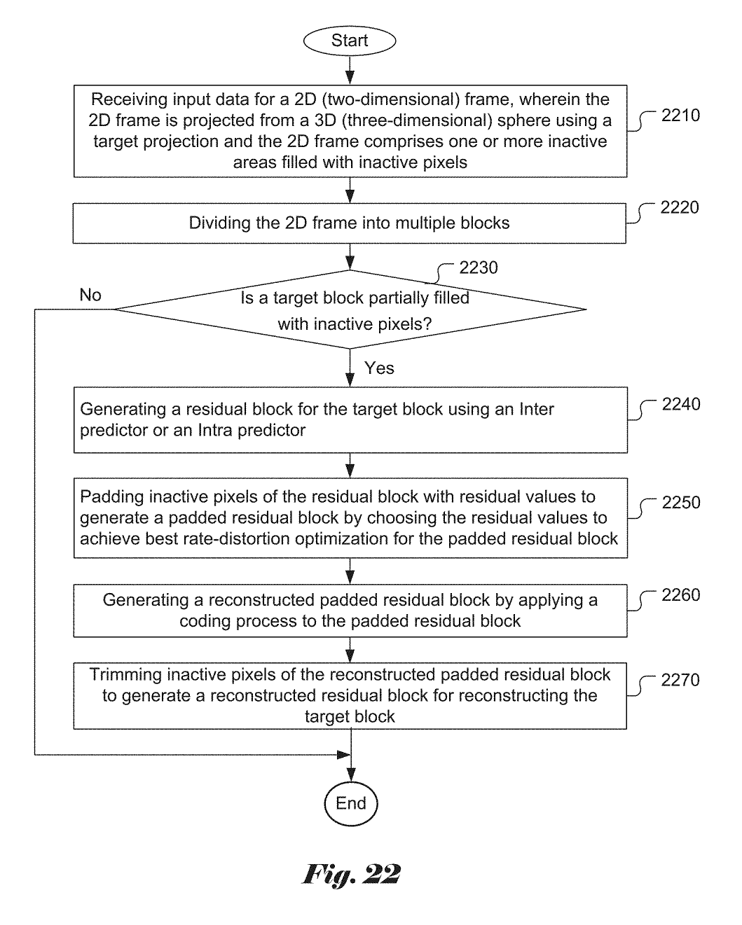

FIG. 22 illustrates an exemplary flowchart of a coding system for processing 360-degree virtual reality images, where the inactive pixels of a residual block are padded with values to achieve the best rate-distortion optimization. According to this embodiment, input data for a 2D (two-dimensional) frame are received in step 2210, where the 2D frame is projected from a 3D (three-dimensional) sphere using a target projection and the 2D frame comprises one or more inactive areas filled with inactive pixels. The 2D frame is divided into multiple blocks for processing in step 2220. Whether a target block is partially filled with inactive pixels is checked in step 2230. If the target block is partially filled with inactive pixels (i.e., the “yes” path from step 2230), steps 2240 to 2270 are performed. Otherwise (i.e., the “no” path from step 2230), steps 2240 to 2270 are skipped. In step 2240, a residual block for the target block is generated using an Inter predictor or an Intra predictor. In step 2250, inactive pixels of the residual block are padded with residual values to generate a padded residual block by choosing the residual values to achieve best rate-distortion optimization for the padded residual block. In step 2260, a reconstructed padded residual block is generated by applying a coding process to the padded residual block. In step 2270, inactive pixels of the reconstructed padded residual block are trimmed to generate a reconstructed residual block for reconstructing the target block.

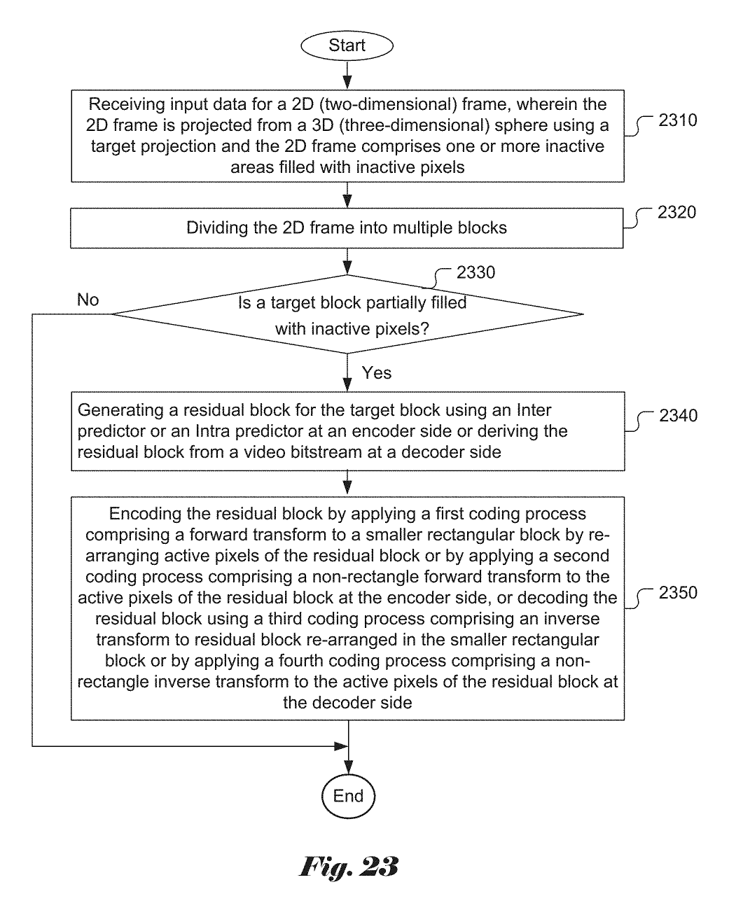

FIG. 23 illustrates an exemplary flowchart of a coding system for processing 360-degree virtual reality images, where active pixels of the residual block are rearranged into a smaller block and coding is applied to the smaller block, or shape-adaptive transform coding is applied to the active pixels of the residual block. According to this embodiment, input data for a 2D (two-dimensional) frame are received in step 2310, where the 2D frame is projected from a 3D (three-dimensional) sphere using a target projection and the 2D frame comprises one or more inactive areas filled with inactive pixels. The 2D frame is divided into multiple blocks for processing in step 2320. Whether a target block is partially filled with inactive pixels is checked in step 2330. If the target block is partially filled with inactive pixels (i.e., the “yes” path from step 2330), steps 2340 to 2350 are performed. Otherwise (i.e., the “no” path from step 2330), steps 2340 to 2350 are skipped. In step 2340, a residual block for the target block is generated using an Inter predictor or an Intra predictor at an encoder side or the residual block is derived from a video bitstream at a decoder side. In step 2350, the residual block is encoded by applying a first coding process comprising a forward transform to a smaller rectangular block by re-arranging active pixels of the residual block or by applying a second coding process comprising a non-rectangle forward transform to the active pixels of the residual block at the encoder side, or the residual block is decoded using a third coding process comprising an inverse transform to residual block re-arranged in the smaller rectangular block or by applying a fourth coding process comprising a non-rectangle inverse transform to the active pixels of the residual block at the decoder side.

The flowcharts shown above are intended for serving as examples to illustrate embodiments of the present invention. A person skilled in the art may practice the present invention by modifying individual steps, splitting or combining steps with departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more electronic circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of processing 360-degree virtual reality images, the method comprising:
receiving input data for a 2D (two-dimensional) frame, wherein the 2D frame is projected from a 3D (three-dimensional) sphere using a target projection and the 2D frame comprises one or more inactive areas filled with inactive pixels;
dividing the 2D frame into multiple blocks; and
when a target block is an inactive block with all pixels being inactive pixels, skipping coding flags for the target block at an encoder side or deriving pixels for the target block based on information identifying the target block being the inactive block at a decoder side.

2. The method of claim 1, wherein the coding flags comprise one or more elements selected from a group including prediction mode, prediction information, split mode and residual coefficient.

3. The method of claim 1, wherein default coding flags are assigned to the coding flags at the encoder side or the decoder side.

4. A method of processing 360-degree virtual reality images, the method comprising:
receiving input data for a 2D (two-dimensional) frame, wherein the 2D frame is projected from a 3D (three-dimensional) sphere using a target projection and the 2D frame comprises one or more inactive areas filled with inactive pixels;
dividing the 2D frame into multiple blocks; and
when a target block is partially filled with inactive pixels:
for at least one candidate reference block in a selected reference picture area, identifying inactive pixels in the candidate reference block, or for at least one candidate Intra prediction mode in an Intra prediction group, padding one or more reference samples in a candidate Intra predictor associated with said at least one candidate Intra prediction mode with a nearest available reference or removing said at least one candidate Intra prediction mode from the Intra prediction group if said one or more reference samples are unavailable;
selecting a best predictor among candidate reference blocks in the selected reference picture area or among candidate Intra predictors associated with candidate Intra prediction modes in the Intra prediction group according to rate-distortion optimization, wherein distortion associated with the rate-distortion optimization is measured by excluding inactive pixels of the target block; and
encoding the target block using the best predictor.

5. The method of claim 4, wherein inactive pixels of said at least one candidate reference block are replaced by a default value before the best predictor is used for encoding the target block.

6. The method of claim 4, wherein inactive pixels of the best predictor selected among the candidate Intra predictors associated with candidate Intra prediction modes in the Intra prediction group are replaced by a default value before the best predictor is used for encoding the target block.

7. The method of claim 4, wherein the distortion associated with the rate-distortion optimization is measured according to a sum of absolute differences between the target block and one candidate reference block or between the target block and one candidate Intra predictor.

8. A method of processing 360-degree virtual reality images, the method comprising:
receiving input data for a 2D (two-dimensional) frame, wherein the 2D frame is projected from a 3D (three-dimensional) sphere using a target projection and the 2D frame comprises one or more inactive areas filled with inactive pixels;
dividing the 2D frame into multiple blocks; and
when a target block is partially filled with inactive pixels:
generating a residual block for the target block using an Inter predictor or an Intra predictor;
padding inactive pixels of the residual block with residual values to generate a padded residual block by choosing the residual values to achieve best rate-distortion optimization for the padded residual block;
generating a reconstructed padded residual block by applying a coding process to the padded residual block; and
trimming inactive pixels of the reconstructed padded residual block to generate a reconstructed residual block for reconstructing the target block.

9. The method of claim 8, wherein distortion associated with the rate-distortion optimization is measured according to a sum of absolute differences between the padded residual block and the reconstructed padded residual block.

10. The method of claim 8, wherein distortion associated with the rate-distortion optimization is measured by excluding inactive pixels of the padded residual block.

11. The method of claim 8, wherein the coding process comprises forward transform, quantization, inverse quantization and inverse transform.

12. A method of processing 360-degree virtual reality images, the method comprising:
receiving input data for a 2D (two-dimensional) frame, wherein the 2D frame is projected from a 3D (three-dimensional) sphere using a target projection and the 2D frame comprises one or more inactive areas filled with inactive pixels;
dividing the 2D frame into multiple blocks; and
when a target block is partially filled with inactive pixels:
generating a residual block for the target block using an Inter predictor or an Intra predictor at an encoder side or deriving the residual block from a video bitstream at a decoder side; and
encoding the residual block by applying a first coding process comprising a forward transform to a smaller rectangular block by re-arranging active pixels of the residual block or by applying a second coding process comprising a non-rectangle forward transform to the active pixels of the residual block at the encoder side, or decoding the residual block using a third coding process comprising an inverse transform to residual block re-arranged in the smaller rectangular block or by applying a fourth coding process comprising a non-rectangle inverse transform to the active pixels of the residual block at the decoder side.

13. The method of claim 12, wherein the non-rectangle forward transform corresponds to forward shape-adaptive transform and the non-rectangle inverse transform corresponds to inverse shape-adaptive transform.

14. The method of claim 13, wherein the forward shape-adaptive transform process comprises a first 1-D DCT (discrete cosine transform) process in a first direction, aligning first results of the first 1-D DCT process to a first board in the first direction, a second 1-D DCT process in a second direction, and aligning second results of the second 1-D DCT process to a second board in the second direction; and the inverse shape-adaptive transform process comprises a first inverse 1-D DCT process in the first direction, restoring first results of the first inverse 1-D DCT process to original first positions in the first direction, a second inverse 1-D DCT process in the second direction, restoring second results of the second inverse 1-D DCT process to original second positions in the second direction.
